(19) United States
(12) Patent Application Publication
(10) Pub. No.: US 2006/0250744 A1
(43) Pub. Date: Nov. 9, 2006

(54) Micro gap method and ESD protection device

(76) Inventors: Michael T. McTigue, Colorado Springs, CO (US); James E. Cannon, Colorado Springs, CO (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/122,618

(22) Filed: May 5, 2005

(51) Int. Cl. H02H 9/00

(52) U.S. Cl. 361/120

(57) ABSTRACT

ESD events on a hybrid circuit are suppressed with a high performance spark gap cut in a metal trace with a suitable laser micro machining technique. The trace can be carried by a conventional printed circuit board (using FR4), or a ceramic substrate. Gap size is reduced by flushing the cut with a flow of gas that removes the vaporized copper and prevents it from re-depositing upon the cut surfaces and bridging them. The gap can be as narrow as 0.4 mils (0.0004 inches) and can have very well defined features that include sharp corners that assist in lowering the breakdown voltage. In addition, dielectric material below and off to either side of the trace that would otherwise adjoin the metallic gap can also be removed, which lowers breakdown voltage and decreases capacitance across the gap. Breakdown voltages as low as 300 V can be achieved. Such a spark gap is used at the probe tip of an active oscilloscope probe to protect the delicate circuitry therein.

### BACKGROUND OF THE INVENTION

An active probe assembly for a high frequency oscilloscope needs to be physically small for reasons related to the wavelength of the highest frequencies within the ‘scope’s bandwidth. Accordingly, the coupling and matching networks that connect the actual probe tip(s) to the pre-amplifier input(s) are often physically quite small. The ability of the resistive components in these coupling and matching networks to dissipate power is quite limited, and quite aside from the effects of heating, they can undergo significant permanent changes in value by being exposed to electrostatic stress.

Furthermore, the active devices in such a probe assembly generally occur in integrated semiconductor amplifier assemblies that are often susceptible to damage or destruction from ESD, or electrostatic discharge (i.e., they can get ‘zapped’). A considerable amount of prior art has been devoted to protection of Integrated Circuits (ICs) from ESD, much of which involves structures that are internal to the IC and are sometimes active structures powered by the ESD event itself and located so as to shunt the ESD current away from sensitive devices. Other protection strategies involve more passive breakdown devices constructed in parallel with a node/ground combination to be protected. It is not that these protection devices do not work for protection of ESD. They usually do, but often their presence is frequently not suitable in a controlled impedance environment. You could fully protect a sensitive 50Ω input that ought to operate from DC to 15 GHz with some of the more robust of these protection devices, so long as you didn't expect the full 15 GHz bandwidth to be realized. (Those big juicy SCRs look like HUGE capacitors . . . )

Consider an active probe for a modern high bandwidth oscilloscope or the like. They use pre-amplifiers that are definitely of the controlled impedance variety: transmission line input and transmission line output. Often the pre-amplifier is a differential pair of operational amplifiers that, as a circuit is fairly complicated and is implemented as an IC located on a substrate that is very close to the business end of the scope's probe. Often there are other components mounted on the substrate, such as input isolation resistors and input coupling RC networks, input transmission lines and termination resistors, and the whole assembly is termed a ‘hybrid’ assembly. It may have a few, or even several, discrete parts, one or more ICs and various interconnections. It is usually small, often enclosed in its own package (perhaps even encapsulated), and is generally not considered field repairable. Hybrids are generally replaced even at the depot level as if they were unit item, although they might actually be overhauled at the factory. Given this situation, and the additional fact that the high performance hybrids in active probes are expensive items (some ‘scope vendors even offer a probe loner program to their customers while a smoked probe is being rehabilitated . . . ) it is not surprising that there is still considerable interest in better ESD protection for high frequency hybrid pre-amplifier assemblies. The pre-amplifier may have its own onboard ESD protection, but it is not altogether robust, and we may safely say that anything done to protect the input isolation, coupling and termination components is a welcome addition the lessens the chances that the IC's onboard protection will be overwhelmed by a strong ESD event.

Typical solutions for protecting the input isolation, coupling and termination components for such an active probe often include discrete protection devices carried by a substrate. Once again the significant disadvantage is the parasitic reactance, especially added capacitance that creates a discontinuity in a transmission line structure, such as a strip line, coplanar transmission line, or length of actual coax.

Oddly enough, the lowly spark gap is a popular tool for ESD protection where other devices are unsuitable. It can be made small and often appended to a controlled impedance structure in a way that can be tolerated (or compensated). Its small size limits the amount of added reactance. It is generally fabricated in a metal trace carried on the substrate and relies upon a small gap between the trace and a nearby ground to provide a low arc-over voltage.

Prior art spark gaps for this class of service have heretofore been constructed both with photo-lithographic techniques and with laser etched cuts in metallic traces. The typical prior art hybrid spark gap formed with photolithography has a gap of about two mils (0.002 inches) and breakdown voltage in the range of 1.5 KV. The HP 1152A active probe had a (YAG) laser cut gap in a trace connecting the probe tip to ground. The narrowest cut obtainable was in the range of two to three mils wide with breakdown voltages in the range of 1.5 KV to 2 KV.

The preferred place to locate an outermost level of ESD protection is right at the probe tip(s). This, if it can be done, will protect the isolation and coupling networks that electrically couple the signal(s) into the pre-amplifier. It will reduce the burden on the internal ESD protection that the pre-amplifier needs to have, which eases any interference that such internal ESD protection may produce regarding high frequency operation. However, a spark gap to ground carried by a probe tip intended to operate a high frequencies (15-20 GHz) is not a benign thing. There is a length of conductor involved that at worst can create a resonance, and that at a minimum adds some amount of unwanted reactance that appears as circuit loading or that alters the probe's frequency response. Fortunately, there is a good compromise (earlier used in the HP 1152A) that is fairly easy to implement. The length of conductor is isolated at each end by a spark gap: at one end by a gap that ‘connects’ it to the probe tip, and at the other end by a gap that ‘connects’ it to ground. Thus, the bulk of the conductor ‘isn't there’ electrically except when an ESD event occurs. During an ESD event the spark gaps act as closed switches, and at other times as low capacitance open switches whose capacitances are in series, and thus appear diminished. The reactance of the intervening conductor is ‘suspended,’ as it were, between the two open switches.

One might think that, as in conventional series component behavior, that two small spark gaps in series would have exhibit the sum of their individual breakdown voltages seen when operated in isolation. For some reason not altogether clear, this is not so. Two small 300 V spark gaps can be placed in series to produce a composite result having a breakdown of, say, 325 V to 350 V. However, the trick is to be able to reliably make such a small spark gap in a production setting.

The typical present day breakdown voltage of 1.5 KV to 2 KV for conventional spark gaps is often insufficient protection. Furthermore, the tight tolerances needed to produce smaller gaps are difficult or impossible to maintain with photo-lithographic techniques, and various problems have heretofore beset the laser technique to prevent the cutting of smaller gaps in metallic traces for economical commercial production. For maximum protection of downstream components, we should like to electrically locate this spark gap right at the very probe tip(s), which is a dangerous place indeed to place any significant stray reactance. We need a better spark gap. What to do?

### SUMMARY OF THE INVENTION

A solution to the problem of suppressing ESD events on a hybrid circuit with a high performance spark gap is to cut a gap in a metal trace with a suitable laser micro machining technique. The metal trace can be 0.5 mil copper carried by a conventional printed circuit board (using FR4), or a ceramic substrate such as is often used to make a thick film hybrid. Gap size is reduced by flushing the cut with a flow of suitable gas, such as CO₂, that removes the vaporized copper and prevents it from re-depositing upon the cut surfaces and bridging them. The gap can be as narrow as 0.4 mils (0.0004 inches) and can have very well defined features that include sharp corners that assist in lowering the breakdown voltage. In addition, dielectric material below and off to either side of the trace that would otherwise adjoin the metallic gap (and that would thus effectively capacitively bridge the gap) can also be removed. This is believed to also lowers breakdown voltage (compared to photo-lithography, which does not remove such dielectric material) and also decreases capacitance across the gap. Breakdown voltages as low as 300 V can be achieved.

### BRIEF DESCRIPTION OF THE DRAWINGS

FIG. 1 is a simplified plan view of a prior art spark gap formed by photolithography on a substrate for ESD protection;

FIG. 2 is a simplified side view of a micro gap ESD protection device being formed on a substrate in accordance with the principles of the invention;

FIG. 3 is a simplified top view of the micro gap ESD protection device of FIG. 2 in use for one preferred embodiment involving a high frequency differential active probe for an oscilloscope;

FIG. 4 is a schematic diagram of one electrical embodiment for a high frequency differential active probe for an oscilloscope where micro gap ESD protection devices are used; and

FIG. 5 is a simplified plan view of an alternate manner of creating a micro gap ESD protection device on a substrate.

### DESCRIPTION OF A PREFERRED EMBODIMENT

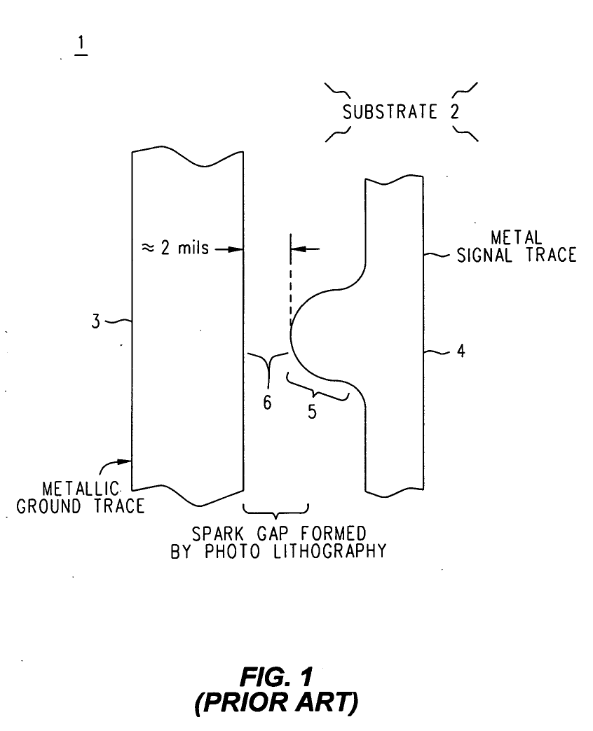

Refer now to FIG. 1, wherein is shown a simplified representation 1 of a prior art spark gap structure fabricated by photolithography upon a substrate 2. A metallic signal trace 3 passes near a metallic ground trace 4 that also carries a bulge 5. The bulge 5 approaches trace 3 to produce a gap 6 that is the actual spark gap of about 2 mils (0.002 inches). It will be appreciated that this is representative depiction, and that roles of the signal and ground traces could be reversed, and that each might have a bulge approaching the other. On the other hand, at high frequencies the bulge may appear as an unwelcome lumped constant, and a designer may prefer to keep his or her signal traces ‘bulge free,’ and locate a single bulge in the ground trace.

In any event, those familiar with such techniques will appreciate that it is not possible to control the process variables closely enough to reliably produce a significantly narrower spark gap. Furthermore, the definition of the shapes is not ‘crisp,’ in that sharp well defined corners and edges are not produced. This rounding of features increases breakdown voltage by distributing the gradient of the electric field, rather than concentrating it to lower breakdown voltage. Finally, there is no removal of dielectric substrate, and its continued presence in the vicinity of the gap increases capacitance, which is undesirable.

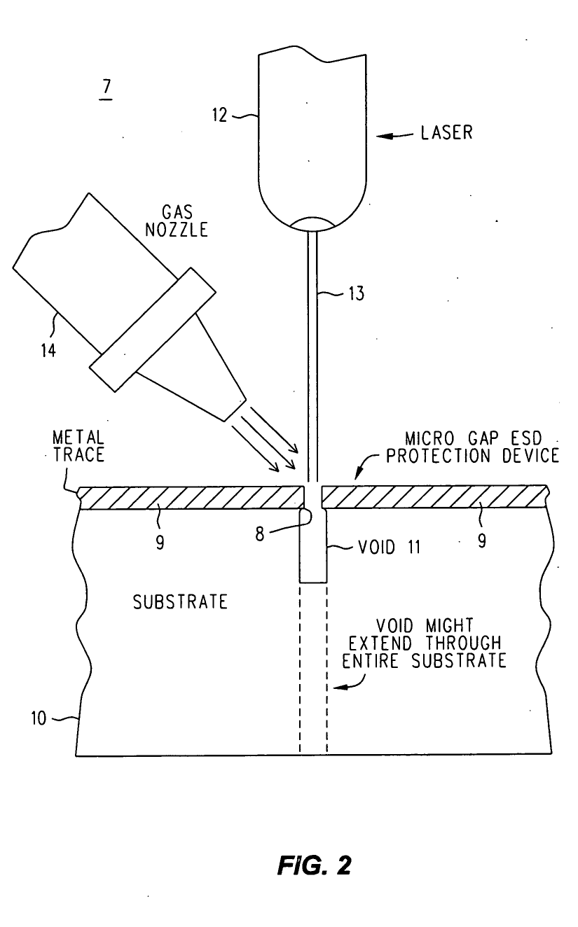

FIG. 2 is a fanciful depiction of a preferred method 7 of creating a micro gap ESD protection device. A narrow gap 8 is formed in a metal layer 9, which might be either a trace or a larger area serving as a ground plane. The gap 8 can be as narrow as about 0.4 mils in width, and the metal layer can be copper about 0.5 mils in thickness. The substrate 10 carrying the metal 9 can be FR4 or ceramic. The laser 12 is preferably a copper vapor laser, which produces light in the far ultra-violet range that is readily absorbed by copper. In a known manner it will produce a beam 13 that is not quite as wide as the width of the cut 8 that is to be made. An optional gas nozzle 14 may direct a flow of a suitable gas (CO₂ is good) toward the location of the cut to wash vaporized metal and other debris away from the cut. Any inert gas, or other gas that does not react with the materials involved would be suitable. A gas supply pressure often psi and an orifice of 0.020 inches is sufficient for making the narrow cuts described herein. This flow of gas will prevent a condensation of metal vapor that can clutter up the cut, and sometimes even bridge it.

The substrate 10 with its metal 9 is made to translate beneath the laser 12 nozzle 14 combination. Commercially available stages may be used for this, and either the substrate and metal or the laser and nozzle can be stationary while the other combination moves. Assuming that a micro gap ESD device is to located in a trace of about 0.005 inches in width, the actual length of cut is preferably about twice that, or 0.010 inches. With a gas wash, two cutting passes can be made for 0.5 mil copper metal 9. Each pass takes about two seconds, and the second pass is identical to the first (i.e., backed up with laser off, and then repeated in the original direction and without translation to widen the cut). The cut will extend into the substrate, which in our application is desirable, as it reduces capacitance across the gap by removing nearby dielectric. If desired, additional passes can be made to deepen the cut, so that it might actually go all the way through the substrate 10.

It will be noticed that in FIG. 2 we have shown the cut into the substrate 10 as void 11. Typically, the steps described above will produce a void 11 in the substrate 10 that is slightly wider than the width of the gap 8 in metal 9. It appears that this arises from the substrate vaporizing more readily than does the copper metal 9.

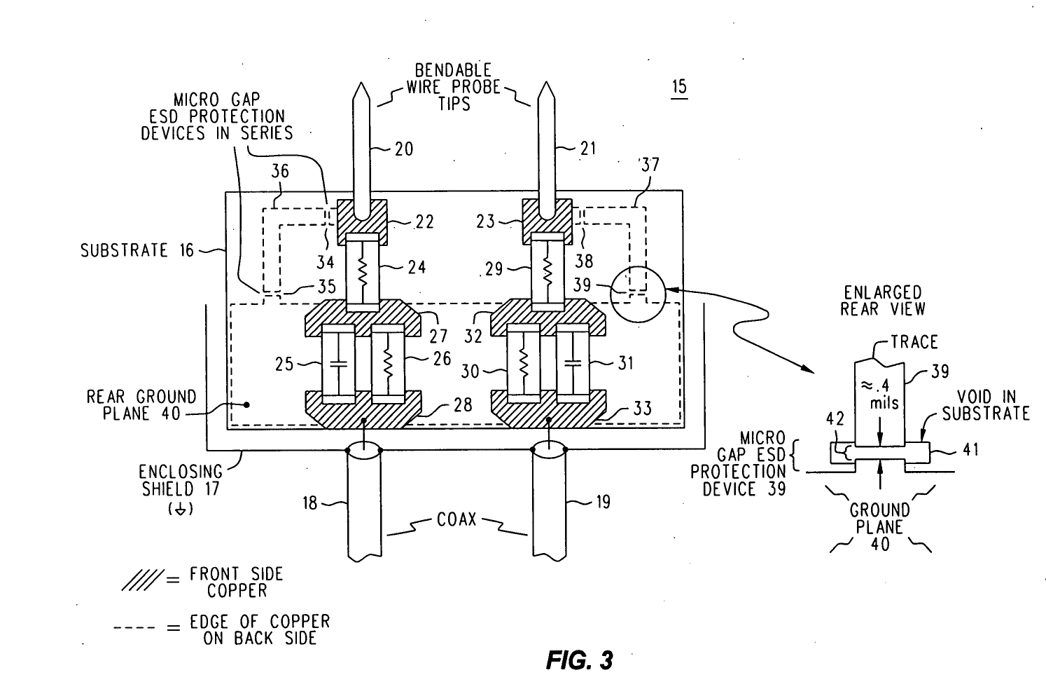

And, although we have not shown in FIG. 2 (we will in the inset of FIG. 3), it is also desirable that the cut extend beyond both sides of a trace. Not only does this ensure that there is no sliver or feather edge of metal left to short across the gap, it also decreases capacitance across the gap by removing nearby dielectric material.

In the absence of a jet of gas to wash away debris, it has been found useful in the practice of one embodiment of the method for fabricating micro gap ESD devices to conduct a third pass with the laser beam slightly de-focused. This will remelt any copper debris or metal fragments and allow surface tension to collect them along the edges of the cut, but without any significant further cutting. It also guards against any low conductivity path bridging the gap and formed by a layer of fine copper dust.

Refer now to FIG. 3, which is a depiction of a high frequency probe tip assembly 15 protected by micro gap ESD protection devices located directly at the probe tips and fabricated in accordance with the principles of the method described above. FIG. 3 is not a true pictorial view, although it has definite pictorial content, and it is not a true schematic, although it reveals actual circuitry; it is a hybrid view, which properly understood, conveys much useful information.

Let us begin with trace pads 22 and 23. They are on what we will call the front, or component, side of a substrate 16. They have holes drilled completely through them, into which are inserted wires 20 and 21, respectively. The holes are plated through vias to small pads (not visible) on the back side of the substrate. The combination of the vias and the wire create an excellent ‘pop-thru’ from the front side of the substrate to the back side. Let us first dispose of the rest of what is shown on the front side, after which we shall discuss the stuff on the back.

Wires 20 and 21 are chosen for a suitable combination of stiffness and bendability: they are the actual probe tips and are expected to be bent as needed to achieve different spacings there between. They are also pointed at their business ends, the better to poke into a trace or solder joint and then stay poked by not slipping.

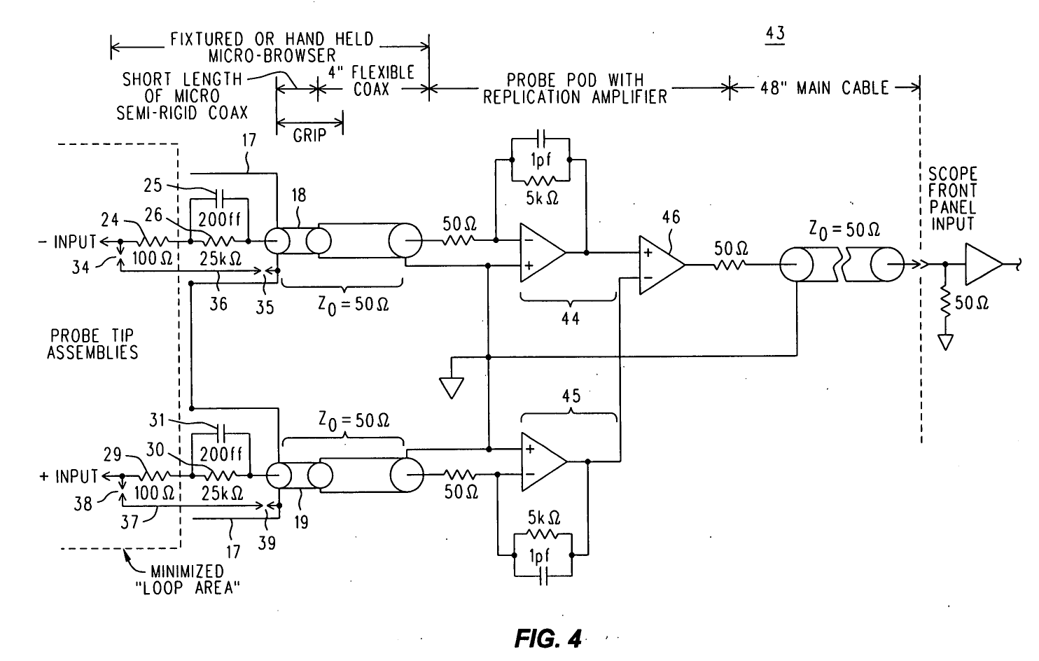

Pad 22(23) also serves as a mounting pad for one end of a 100Ω isolation/damping resistor 24 (29) whose other end is soldered to pad 27 (32). Pad 27 (32) also serves to solder one end of each of resistor 26 (30) and capacitor 25 (31), whose other ends are soldered to pad 28 (33). These resistors and capacitors may be small surface mount components. Parallel RC combination 26/25 (30/31) is a coupling network that basically sets the input impedance of the probe (say, 25 KΩ shunted by 200 ff), while coupling the signal to the center conductor of a 50Ω coaxial transmission line 18 (19). The other end of the coax 18 (19) is connected to a 50Ω termination resistor (not shown) at the input to a replication amplifier (also not shown). A bit of extra detail concerning how this electrical arrangement works will be given in connection with the discussion of FIG. 4, which is electrically very similar to that of FIG. 3, but which is physically somewhat different.

Note the enclosing shield 17. Here our figure takes some liberties. One the one hand, there IS an enclosing shield, and for the back side of the assembly it is the ground plane 40, indicated in phantom view by its dashed outline. The other (front) side of the enclosing shield is a corrugated metal lid whose cross section is rather like a W, and that has provisions to fit over the front side of the substrate 16 while extending (into the figure) to be soldered to the left and right edges of the ground plane 40. The corrugations provide room to clear the RC components 24-26 and 29-31. They also neck down to allow a solder joint to each of the shields of coax cables 18 and 19.

Now for what's on the back side of the substrate. Note traces 36 and 37, and temporarily ignore gaps therein 34, 35, 38 and 39. As originally formed, trace 34 extends in an unbroken manner from beneath pad 22 to ground plane 40, while trace 37 does likewise from beneath pad 23. The end of trace 36 (37) that is beneath pad 22 (23) receives the through hole via mentioned earlier, and has the non-pointed end of wire 20 (21) soldered thereto. (The reader may be wondering why it is that these traces 36 and 37 have dog legs, instead of taking the direct route, which would be underneath resistors 24 and 29, respectively. This is a high frequency assembly, after all, and a bend is an expense incurred in terms of reactance, best left avoided if possible. The answer is that the direct path has various holes drilled in and around it, which serve to trim the impedance of the main signal path. So, the traces 36 and 37 can't go there. Besides, traces 36 and 37 are not, strictly speaking, part of the main signal path; they will only be needed to carry the current of an ESD event.) As described in the previous paragraph, if the gaps in micro gap ESD protection devices 34, 35, 38 and 39 were not present, trace 36 (37) would (DC!) short input probe tip 20 (21) to ground. That, of course, does not comport with the fundamental purpose of the probe. However, that difficulty vanishes as soon as the micro gaps ESD devices (34, 35, 38, 39) are formed.

It will be noted that there is one micro gap spark gap ESD protection device formed (using the previously described method) at what is essentially each end of trace 36 and of trace 37. This has the beneficial effect of isolating the reactance associated with the bulk of the length of the trace (36 & 37) from both the input terminal (probe tips 20 and 21) and ground. This nifty trick does not completely eliminate it at the highest frequencies, but it is sufficient to move ‘out of band’ any appreciable effects of the remaining disturbance to the desired impedance.

A close-up detail of micro gap ESD protection device 39 (which is representative of the other three) is shown in the inset at the right of FIG. 3. It is a top view from the rear, so the edges of the trace 39 and ground plane 40 are no longer dotted. Shown there is a narrow gap 42, which may be as narrow as 4/10 mils, beneath which is a void 41 in the substrate. The void 41 is typically somewhat wider than the gap 42 and preferably extends beyond either side of the trace 39. As mentioned earlier, this removal of dielectric material reduces the capacitance across the gap 42.

Gap 42 (as well as the others in micro gap ESD devices 34, 35 and 38) may have a breakdown, or flash over voltage of as low as 300 V. Our experiments with such narrow spark gaps over dielectrics and in ambient air have suggested that narrower gaps do not appreciably lower the breakdown voltage; it stays at about 300 V. We are aware of a different technique for producing gaps in copper upon dielectric that are just ¼ mil in width, and even they exhibit the 300 V property. It seems probable that at a small scale such a spark gap is more of a machine (i.e., it has several cooperating parts or controlling mechanisms) than it appears, and that simple explanations of its behavior are inadequate. This view is bolstered by further observations that two such spark gaps in series do not have a breakdown voltage that is the sum of voltages for the individual gaps. Instead, it stays at about 300 V. We have not investigated the reasons for these behaviors, nor do we know if others have; we are here simply reporting our observations gathered during development of what is disclosed herein. We expect that the they are essentially valid for the range of operating conditions that the associated equipment (a laboratory quality oscilloscope) is expected to operate in: e.g., from about sea level to 15,000 feet at −20° C. to 50° C. with non-condensing humidity. So, while we don't know how to get the voltage down to, say, 150 V, 300 V ain't bad, and there is no penalty of increased voltage for using two micro gaps in series to isolate the length of trace that couples the probe tip to ground.

We turn now to FIG. 4, which is a simplified schematic 43 of a high frequency differential probe having the same electrical architecture as that of FIG. 3, although it has a somewhat different physical nature for the probe tips. FIG. 4 is, in the main, taken from an earlier filed U.S. patent application Ser. No. 10/945,146 entitled HIGH FREQUENCY OSCILLOSCOPE PROBE WITH UNITIZE PROBE TIPS filed by Mike McTigue and James E. Cannon on 20 Sep. 2004 and assigned to Agilent Technologies, Inc. It is directed to a manner of construction for the probe tip assemblies, and related material shows the amplifier architecture with which it cooperates. That amplifier architecture is in turn the subject matter of U.S. Pat. No. 4,473,839 issued to Rush on 10 May 1988 and entitled WIDE BANDWIDTH PROBE USING POLE-ZERO CANCELLATION and also U.S. Pat. No. 6,483,284 B1 issued to Eskeldson, et al. on 19 Nov. 2002 and similarly entitled WIDE-BANDWIDTH PROBE USING POLE-ZERO CANCELLATION. Those seeking more information about the specifics of how wideband probe performance is obtained with this architecture can refer to these Patents.

We will, however, engage in a very brief description of what goes on in FIG. 4. Items therein that are comparable to counterparts in FIG. 3 have been given to the same reference numerals. First, the electrical part. The schematic shows driving a 50Ω transmission line 18 (19) with a parallel RC combination of 25 KΩ and 200 ff. While the transmission line is properly terminated in 50Ω at the input of the amplifier (44,45), this is certainly a recipe for rolling off signal amplitude as frequency increases. The replication amplifiers 44 and 45 have essentially the inverse response, so that their overall response to the signals, and thus their difference from amplifier 46, is basically flat. The interesting physical property of the arrangement shown in FIG. 4 is that the spacing between the probe tips is variable by a rotation of two probe assemblies relative to each other. Despite this feature, the two shields (17) remain in contact at their edges closest to the probe tips to minimize a loop area that would otherwise act as an unwanted antenna at high frequencies.

What FIG. 4 shows is the inclusion of the micro gap ESD protection devices 34, 35, 38 and 39, as well as their respective intervening conductors 36 and 37.

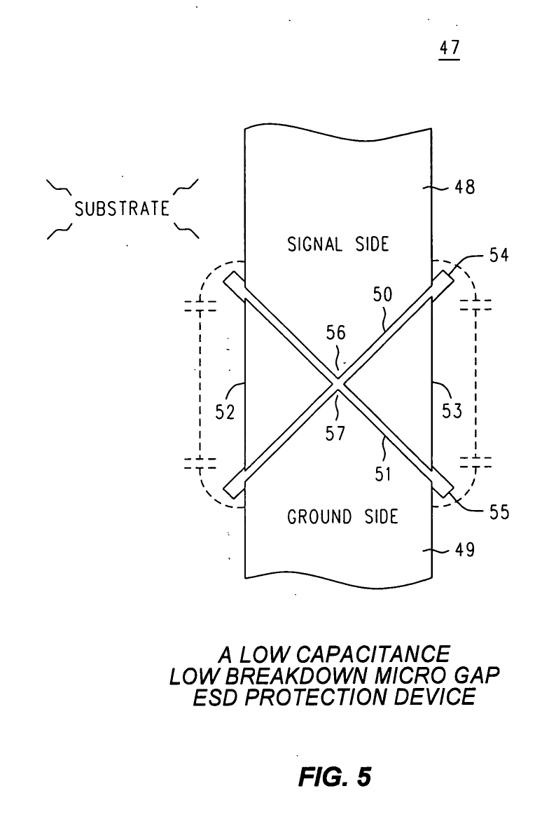

Finally, note the manner of forming an alternate micro gap ESD protection device 47 shown in FIG. 5. In this embodiment a trace 48 upon a substrate is cut twice by cuts 50 and 51 that are right angles to each other and at 45° to the sides of the trace. This produces two ‘left-over’ triangular sections 52 and 53 that may be either left in place or etched away, as desired. Do note the voids 54 and 55 in the substrate.

It can be shown that even if the triangular left-overs 52 and 53 remain, the capacitance from 48 to 49 is less than what would obtain for a same size single 90° cut across the trace (as shown in the inset of FIG. 3). Meanwhile, the points 56 and 57 offer the most concentrated electric fields, for the least breakdown voltage. And in the case where the triangular left-over 52 and 53 remain, if the points 56 and 57 undergo erosion owing to high currents within an ESD event, then the balance of the cuts automatically begin to function as two micro gaps in series, as earlier described.

We claim:

1. A method of forming a spark gap in metallic foil adhering to a substrate, the method comprising the steps of:
(a) removing a strip across the metallic foil with a laser beam;
(b) removing a strip of substrate material beneath the strip of foil removed in step (a), the removed strip of substrate material being longer than the strip of removed foil; and
(c) during steps (a) and (b), directing a flow of gas toward where the strips are being removed.

2. A method as in claim 1 wherein the laser is a copper vapor laser and wherein the metallic foil is of copper.

3. A method as in claim 1 where in the strip removed in step (a) is about 0.0004 inches in width.

4. A method as in claim 1 further wherein the flow of gas in step (c) is of CO₂.

5. An active probe tip assembly for an oscilloscope probe having a spark gap formed with the method of claim 1 and electrically disposed between the probe input and ground.

6. An active probe tip assembly as in claim 5 wherein the spark gap comprises a combination of two spark gaps in series, and the breakdown voltage for the combination is less than 400 volts.

7. A method of forming a spark gap in metallic foil adhering to a substrate, the method comprising the steps of:
(a) removing a strip across the metallic foil with a laser beam;
(b) removing a strip of substrate material beneath the strip of foil removed in step (a), the removed strip of substrate material being longer than the strip of removed foil; and
(c) subsequent to steps (a) and (b), de-focusing the laser and irradiating the edges of the metallic foil created by the removal of the strip in step (a).

8. A method as in claim 7 wherein the laser is a copper vapor laser and wherein the metallic foil is of copper.

9. A method as in claim 7 where in the strip removed in step (a) is about 0.0004 inches in width.

10. An active probe tip assembly for an oscilloscope probe having a spark gap formed with the method of claim 7 and electrically disposed between the probe input and ground.

11. An active probe tip assembly as in claim 10 wherein the spark gap comprises a combination of two spark gaps in series, and the breakdown voltage for the combination is less than 400 volts.
